(19) United States
(12) Patent Application Publication
(10) Pub. No.: US 2009/0145421 A1
(43) Pub. Date: Jun. 11, 2009

(54) Portable outdoor gas oven and grill

(76) Inventor: Dominick Yufer, Beach Wood, NJ (US)

Correspondence Address: Robert Yufer, Barbara Yufer, Tricia Yufer, 1024 Ship Avenue, Beach Wood, NJ, 08722, US

(21) Appl. No.: 11/999,491

(22) Filed: Dec. 6, 2007

(51) Int. Cl. A47J 37/00

(52) U.S. Cl. 126/25 R

(57) ABSTRACT

An improved portable gas oven and grill adapted for outdoor use consisting of a metal grill on top of a metal oven comprising an oven chamber, at least one burner positioned at the bottom of the oven chamber, a thermostat operatively connected to the burner for indicating and controlling the temperature of the oven chamber, and at least one removable shelf within the oven chamber for placement of food therein.

### FIELD OF THE INVENTION

The present invention relates to an improved portable outdoor gas oven and grill.

### BACKGROUND OF THE INVENTION

There has long been a need for a portable gas powered gas oven and grill that can be used for cooking a wide variety of foods at one time together. Previously, outdoor cooking has required a number of separate outdoor cooking equipment to prepare a wide variety of foods. It is desirable to prepare such wide variety of foods in a different manner in order to utilize all of the cooking functions of barbecuing, roasting and baking together at the same time. Therefore, a need exists for an improved portable outdoor gas oven and grill to overcome the limitations of the prior art.

### SUMMARY OF THE PRESENT INVENTION

It is an object of the present invention to provide an improved gas oven and grill

It is another object of the present invention to provide a portable outdoor gas oven and grill.

Another object of the present invention is to provide an outdoor gas oven having a thermostat for controlling the temperature therein.

These and other objects of the present invention are accomplished through the use of a metal grill connected to and positioned above a metal oven having an oven chamber therein. At least one burner is positioned in the lower portion of the oven chamber. A thermostat is positioned at the front of the oven for controlling gas supplied to the oven burner and the resultant temperature within the oven chamber. At least one removable metal shelf is provided horizontally within the oven chamber for placement of food to be roasted or baked therein.

The present invention is lightweight and portable. It is provided with at least two legs on one side at the bottom of the oven and two casters wheels on the opposing side at the bottom of the oven. This permits the user to lift the side of the oven having the legs and to push the oven on the casters wheels so as to easily transport the combined gas oven and grill to another location.

The present invention is operatively connected to a conventional propane gas tank.

Alternatively, the present invention may be connected to a more permanent natural gas outlet.

These and other objects and advantages of the present invention will become apparent to those skilled in the art from the following detailed description of the preferred embodiment.

### BRIEF DESCRIPTION OF THE DRAWINGS

An improved gas oven and grill for outdoor use is depicted in the accompanying drawings which for a part of this disclosure and wherein:

FIG. 1 is a front elevation view of the preferred embodiment of the improved gas oven and grill;

FIG. 2 is a right side elevation view of the preferred embodiment with the front oven door open;

FIG. 3 is a left front perspective view of the oven enclosure;

FIG. 4 is a left front perspective view of the oven chamber for placement within the oven enclosure of FIG. 3;

FIG. 5 is a left front perspective view of the oven chamber of FIG. 4 placed within the oven enclosure of FIG. 3, with the front panel frame removed;

FIG. 6 is a front perspective view of the preferred embodiment of the gas oven and grill, with the oven door removed;

FIG. 7 is a front sectional view of a portion of the left side of the the gas oven along line 7-7′ of FIG. 6;

FIG. 8 is a front sectional view of a portion of the right side of the gas oven along line 8-8′ of FIG. 6: and

FIG. 9 is a schematic view of the gas piping of the gas oven and grill:

### DESCRIPTION OF THE PREFERRED EMBODIMENT

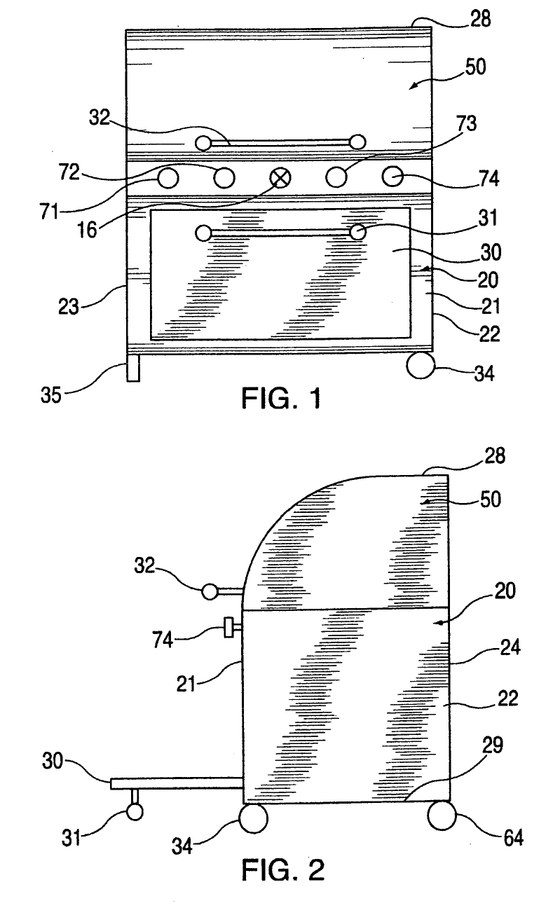

Referring to the drawings by numerals of reference, there is shown in FIGS. 1 and 2 the portable outdoor gas oven and grill of the present invention which comprises: a metal grill, generally referred to as 50, having a horizontal grilling surface panel 27 covered by a metal hood 28 enclosing a grilling chamber 51 therein. The grilling chamber 51 is heated by burning gas from at least one groll burner in an upper gas manifold 8 through gas piping as shown in detail in FIG. 9. The amount of heat from the burner gas supply 70 is controlled by regulator knobs 71, 72, 73, 74. The hood 28 may be raised up away from the grilling chamber 51 by a hood handle 32 attached to the lower front surface of the hood 28.

The improved gas oven, generally referred to as 20 comprises a metal rectangular front panel frame 21 with a rectangular opening 43 therein. Each vertical side of the frame 21 is attached to two opposing and perpendicular rectangular metal side panels 22,23, both of which are attached to a perpendicular rectangular rear metal panel 24. The bottom of the frame 21 is attached to the bottom of the side panels 22,23 and to the bottom of the rear panel 24. The top of the front panel frame 21 is attached to the front of the grilling surface panel 52. The rectangular opening 43 of the front panel frame 21 can be closed by an oven door 30 which can be opened by an oven handle 31 attached to the front of the oven door 30 The bottom left side of the front panel frame 43 and the bottom left side of the rear panel 24 have a downward protruding leg 35, 65 attached thereto. The bottom right side of the front panel frame 43 and the bottom right side of the side panel 23 have a rotating caster 34, 66 attached thereto. The grill and gas oven of the preferred embodiment can be made portable by lifting the left side of the oven 20 so that the protruding legs 35,65 are elevated above the ground and the casters 34, 64 are engaged on the ground so that the oven 20 and top grill 50 can be easily moved to another location.

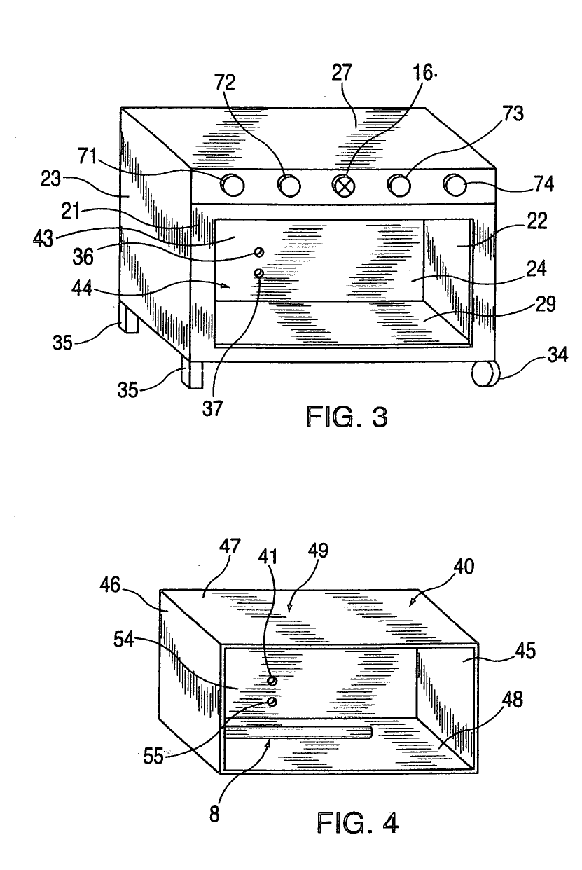

Referring now also to FIG. 3, there is shown the front frame panel 21 with the front frame opening 43 leading to the oven chamber enclosure, generally referred to as 44 which is the box-like enclosure formed by the front frame 21, the side panels 22, 23, the bottom panel 29, the rear panel 24, and the top panel 27. In the center of the rear panel 24 there are two vent holes 36,37 perforating the rear panel 24.

Referring now also to FIG. 4 there is shown the oven chamber, generally referred to as 49, comprised of two opposing rectangular side panels 45, 46 which are attached to top panel 47, rear panel 54, and bottom panel 48 so as to form a box-like oven chamber 49. Above the bottom panel 48 of the oven chamber 49 is provided with at least a lower manifold 12 with at least one gas burner, generally referred to as 8, for heating the oven chamber 49. The center of the rear panel 54 is provided with oven vent holes 41, 55 which are concentric with the oven chamber vent holes 36,37. Such oven chamber vent holes 41, 55 provide for venting of excess heat and combustion products outside through the oven enclosure vent holes 36, 37. The box-like oven chamber 49 is smaller than the box-like oven chamber enclosure 20 to permit insertion of the oven chamber 49 within the oven chamber enclosure 20.

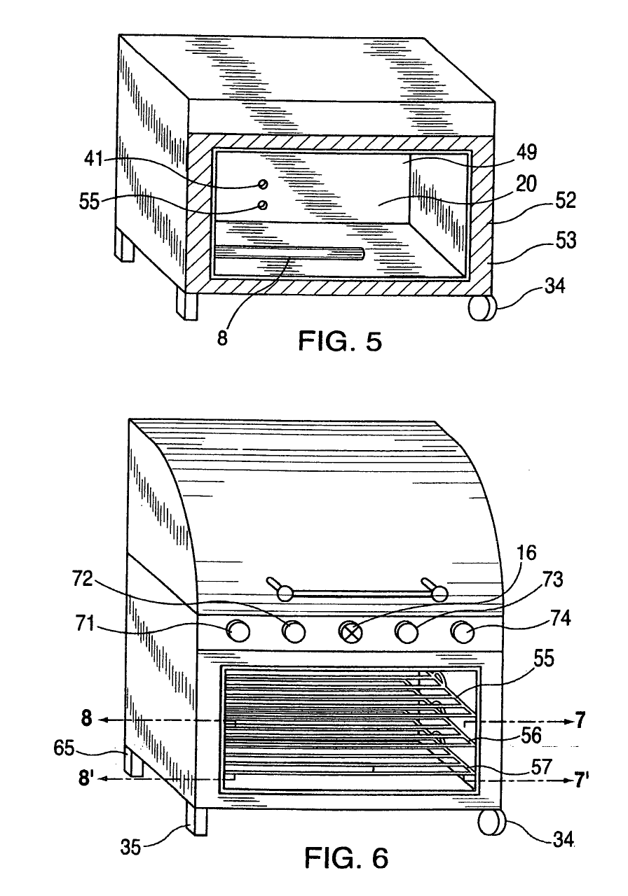

Referring now also to FIG. 5 there is shown the oven chamber 49 inserted within the oven chamber enclosure 20, with the space 52 between the oven chamber 49 and the oven chamber enclosure 20 filled with mineral wool insulation 53 (hatched) in order to save heating energy during use. The front of the oven chamber enclosure 20 has a mineral wool insulated door 30 which can be opened and closed with oven handle 31. The front of the oven frame panel 21 above the oven frame door 30 has a thermostat 16 mounted on the outside surface thereof and operatively connected to the oven chamber 49 for indicating and controlling the temperature within the interior of the oven chamber 49.

Referring now also to FIG. 6 there is shown a left front perspective elevation of the preferred embodiment with the oven door 30 removed. The oven chamber 49 has three horizontal shelves 55, 56, 57 supported therein for the placement of various foods to be roasted or baked.

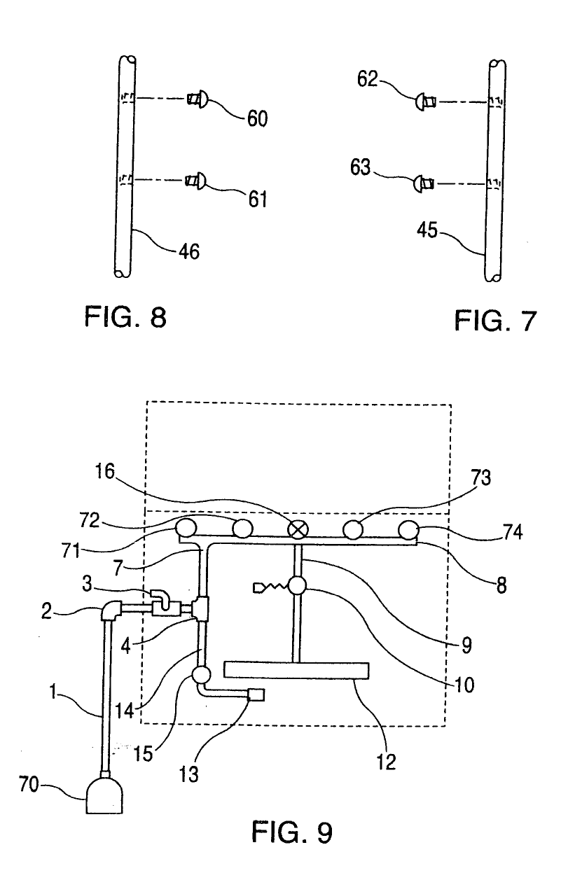

Referring now also to FIGS. 7 and 8 there is shown shelf supporting screws 58, 59, 60, 61, 62, 63 protruding inward toward the interior of the oven chamber side panels 45, 46 for support of the shelves 55, 56, 57.

Referring now also to FIG. 9 there is shown a schematic of the gas piping of the preferred embodiment from the gas supply source. The gas supply source 70 is a propane gas tank attached to the combined gas grill and oven to permit portability of the preferred embodiment. Alternatively, the gas supply source 70 can be a more permanently connected natural gas supply. The gas supply source 70 is connected to a main gas supply pipe 1 which transmits the flow of gas through a threaded elbow 2 and an emergency shutoff valve 3. Thereafter the gas proceeds to a a threaded male Tee fitting 4 which divides the gas to flow upward through a female threaded nut 5 and downward through another female threaded nut 6. The gas flows upward through nut 5 and threaded male pipe 7 to an upper gas manifold which conducts the gas to grill burner regulators 71, 71, 73, 74 which control the gas to the grill burners, generally indicated as 33, wherein the gas is supplied and electrically ignited to heat the grilling surface panel 26. The gas flow upward is also conducted to pass through oven burner regulator 16 wherein the gas flows downward through oven chamber gas supply pipe 19 to the oven chamber burners, generally indicated as 12, wherein the gas is supplied and ignited to heat the oven chamber 49. The gas also flows downward through nut 6 and pilot gas supply tube 14 to a pilot light gas valve 11 wherein the gas is ignited by a pilot light 18 supplied to the gas burners 12. A pilot light shutoff valve 15 is provided in the pilot light tube 14 to close off the pilot light gas supply when the pilot light is not in use.

The present invention has been described by the preferred embodiment set forth above, but it should be understood that this is by way of illustration only and that the present invention is not necessarily limited thereto. Modifications and variations will be apparent from this disclosure and variations will be apparent without departing from the present invention, as those skilled in the art will readily understand. Accordingly, such variations and modifications of the disclosed present invention are considered to be within the purview and scope of the present invention and the following claims.

I claim:

1. An improved outdoor gas oven and grill with a traditional top metal grill having a grilling surface with at least one gas burner mounted thereon for heating the grilling surface, a burner gas regulator knob for controlling the gas supply to the burner, and a hood enclosing the grilling surface, for the placement of food to be grilled therein, wherein the improvement is a box-like metal oven mounted below the grilling surface, comprising:
a rectangular front panel frame having a rectangular opening therein;
an box-like oven chamber enclosure inserted within the rectangular opening;
a box-like oven chamber inserted within the oven chamber enclosure;
at lease one gas burner mounted at the bottom of the oven chamber;
a thermostat operatively connected to the gas burner for indicating and controlling the heat within the oven chamber for cooking the food therein.

2. The improved gas oven and grill of claim 1, wherein the gas is supplied by a propane tank.

3. The improved gas oven and grill of claim 1 wherein the gas supplied is natural gas.

4. The improved gas oven and grill of claim 1 wherein the metal oven has two supporting legs mounted one side below the gas oven, and two casters mounted on the opposing side below the gas oven, whereby the user may lift the oven side having the two legs and transport the gas oven and grill by rolling on the two casters.

5. The improved gas oven and grill of claim 1 wherein the oven and grill are made of lightweight stainless steel sheeting to improve portability.
